(19) United States
(12) Patent Application Publication
(10) Pub. No.: US 2004/0004200 A1
(43) Pub. Date: Jan. 8, 2004

(54) Method and apparatus for flow control in independent units

(76) Inventor: Ronald C. Pescatore, Brooklyn, NY (US)

Correspondence Address: Ladas & Parry, 26 West 61st Street, New York, NY, 10023, US

(21) Appl. No.: 10/191,004

(22) Filed: Jul. 8, 2002

(51) Int. Cl. F16K 31/02

(52) U.S. Cl. 251/129.04

(57) ABSTRACT

An apparatus for flow control in an environment that has independent units includes a flow system for carrying a flow with a controller in one of the units. The apparatus operates the controller from at least one location outside the one of the units in response to a supply of power with a terminal for positioning at the location, a connector for connecting the terminal to the controller, and a power supply for supplying power from the terminal through the connector to the controller when the power supply is connected to the terminal and operating the controller therewith.

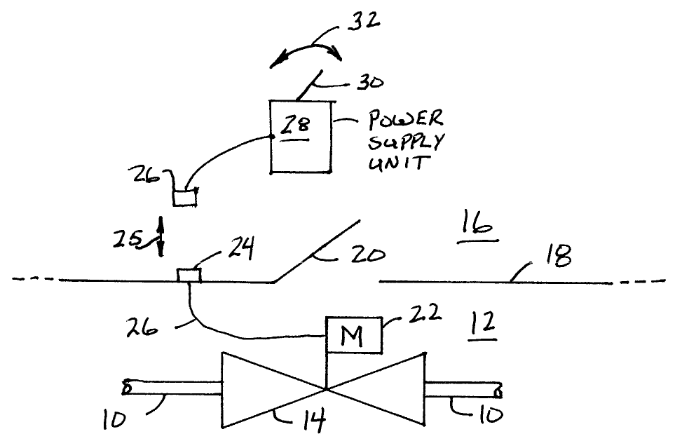

### BACKGROUND OF THE INVENTION

The invention relates to a method and apparatus for flow control in an environment having independent units and, more particularly, water supply control in an apartment building.

Many environments have independent units which restrict access from one of the units to another. For example, a residential or office/industrial environment may have a number of independent home or office/factory units that restrict access to their residents or owners to the exclusion of others who nevertheless have access to common areas such as streets, walks or hallways in or about the environment. Existing smaller residential apartment or office buildings are further examples of such environments for which the invention is particularly intended.

When one of the others who is restricted from access to the independent units of such an environment also has management responsibilities for the environment, like the superintendent of a smaller residential apartment or office building, for example, difficulties can arise when such management requires access to a flow system in one of the units but the independence of the unit prevents this because an apartment tenant is not home, for example. Such flow systems including heating/cooling and/or ventilation supply, electric supply, water supply and water drainage, for example, all have failure modes, like shorts or leaks, for example, that make shut off within a unit desirable more promptly than access to the unit can be obtained from its independent controller in such a case.

Many newer and, especially, bigger environments have remote control systems for controlling a flow system in independent units from a location outside the units. Such remote control systems are especially well known for heating/cooling and ventilating flow control in large newer office buildings. These systems require two sets of connections, however, one to power the flow controller and one, like a relay, for example to control the controller. Such systems are, therefore, more expensive to make, install and maintain than a system in which the controller is both controlled, i.e. operated, and powered by a single power connection. This difference is especially important if the flow control apparatus is being retrofit into an existing building environment and, even more especially, if the building is smaller and/or of lower economic status and, thus, less able to afford such purchase, installation and maintenance.

### SUMMARY OF THE INVENTION

For these and other reasons, an apparatus for flow control in an environment having independent units has a flow system for carrying a flow and a controller therefor in one of the units and an operating system for operating the controller from at least one location outside the one of the units in response to a supply of power. The operating system has a terminal at the location, a connecter for connecting the terminal to the controller, and a power supply arrangement for supplying power from the terminal through the connecter to the controller when the power supply is connected to the terminal for operating the controller therewith.

A method of managing the environment provides such an apparatus to the environment.

### BRIEF DESCRIPTION OF THE DRAWING

A preferred embodiment that illustrates but does not limit the invention is shown in the drawing.

### DESCRIPTION OF THE PREFERRED EMBODIMENT

The preferred embodiment is intended for use in a method of managing an existing smaller and/or lower economic status multi-unit residential or office building by retrofitting its apparatus into an existing water supply flow system in a unit of the building. More particularly, the water supply system in many such buildings has a water tank at the top of the building with a water supply pipe 10 running down from the tank through a first unit 12 and each successive unit on the floors below the tank or, even more usually, through a wall (not shown) separating side-by-side units on each of the floors. Pressure reducing valves (not shown) may be provided at intervals along the water supply pipe if the supply pipe is long enough to require this. The water supply pipe was usually provided in this way to minimize installation cost.

In many cases, therefore, the water supply pipe is effectively in the units of the building, considering the side-by-side units as alternative locations of the water supply pipe in either of these units. Therefore, it is inaccessible from any common area of the building, like a hallway, for example, over most if not all of its length. Although it is usual to provide the water supply pipe at least one shut off valve 14 for the water supply pipe at its tank end, such shut off valve is, therefore, also in the apartment or office unit 12 on the top floor just under the tank, such unit being made independent of a common hallway 16 and other units of the building by a wall 18 and access controlling door 20.

When a leak in the water supply pipe occurs farther along its length, it is desirable to shut off the water supply, but this cannot be done without access to the apartment or office unit 12 in which the shut off valve 14 is. Such access at the time of the leak is problematic. This is, therefore, an environment to which the method and apparatus of the invention is best suited, it being understood from the foregoing description, however, that the invention is also applicable to other environments and flow systems as described as equivalent examples herein.

Therefore, the invention provides a motor 22 or other actuator to the valve 14 in the independent unit 12, a terminal 24 outside the unit, preferably in the hallway 16 or other freely accessible location, and a connection 26 from the terminal to the motor for providing power from the terminal to the motor for controlling the valve. The terminal is preferably a male or female jack for mating as indicated by arrow 25 with a complementary jack 26 of a power supply unit 28 when it is desired to control the valve.

More specifically, a motor operated valve suitable for the invention is made by Watts______of ______as model ______. This is an on/off or gate valve, as shown, but progressive control valves may also be used.

The preferred jack terminal may also be a switch, particularly if the power supply is permanently connected thereto. Inasmuch as the preferred jack or switch can be small and inconspicuous, and because access to its hallway or other location may be partly restricted to unit occupiers and their invitees, it may not be necessary to provide further security to prevent unauthorized supply of power therefrom. However, particularly in the case of a switch connected permanently to a power supply, the terminal may be key operated. In the best mode now contemplated, however, just the mating of complementary jacks is thought to be sufficient security.

The power supply is preferably a low voltage DC supply to minimize the safety requirements for the connection 26 and provide additional security from its less common standard. It is portable as shown. However, the preferred portable power supply unit 28 plugs into a standard AC electric outlet (not shown) to derive its power. Battery operation, although possible and contemplated as an equivalent, is generally too expensive and, in addition, adds the additional operational uncertainty of the battery charge at the time of use.

The power supply, terminal and connection are, of course, adapted to the motor 22. The motor is preferably bi-directionally operational to open and close the valve 14 in dependence on the position of a switch 30 on the power supply unit 28 to the right, as shown, or left as indicated by the arrow 32. With the preferred DC power supply unit, this is done by controlling the polarity of the power supplied to the terminal jack 24.

However, it will be appreciated that the invention is operational with another motor that only operates one way to shut off the valve if the valve is manually or spring operational, for example, to normally be in the opposite open condition. Bi-directional control of the valve is, therefore, preferred but not required in equivalent systems.

Similarly, although the preferred invention has been described as electrically operated, pneumatic or other fluid pressure operation is also possible. In such an embodiment, the terminal and connection are tubes and the motor is responsive to the fluid pressure they provide at least to close the valve, although reverse opening of a the valve by negative pressure (vacuum) is certainly contemplated, too, as an equivalent if not preferred embodiment.

Other variations, combinations and permutations as will occur to those of ordinary skill in the art are contemplated as equivalents within the scope of the following claims.

1. In apparatus for flow control in an environment having independent units, the apparatus including flow means for carrying a flow and a controller therefor in one of the units, the improvements comprising:
operating means for operating the controller from at least one location outside the one of the units in response to a supply of power, wherein the operating means comprises a terminal for positioning at the location, connecting means for connecting the terminal to the controller, and power supply means for supplying power from the terminal through the connecting means to the controller when the power supply means is connected to the terminal and operating the controller therewith.

2. The apparatus according to claim 1, wherein the terminal is a first jack.

3. The apparatus according to claim 2, wherein the terminal is a switch.

4. The apparatus according to claim 1, wherein the terminal is key operated.

5. The apparatus according to claim 1, wherein the power supply means is portable.

6. The apparatus according to claim 2, wherein the power supply is portable and has a second jack complementary to first jack for supplying the power to the terminal.

7. The apparatus according to claim 1, wherein the controller controls the flow means between open and closed conditions, and further comprising selecting means at the power supply means for selecting one of the open and closed conditions.

8. The apparatus according to claim 2, wherein the controller controls the flow means between open and closed conditions, and further comprising selecting means at the power supply means for selecting one of the open and closed conditions.

9. The apparatus according to claim 3, wherein the controller controls the flow means between open and closed conditions, and further comprising selecting means at the power supply means for selecting one of the open and closed conditions.

10. The apparatus according to claim 4, wherein the controller controls the flow means between open and closed conditions, and further comprising selecting means at the power supply means for selecting one of the open and closed conditions.

11. The apparatus according to claim 5, wherein the controller controls the flow means between open and closed conditions, and further comprising selecting means at the power supply means for selecting one of the open and closed conditions.

12. The apparatus according to claim 6, wherein the controller controls the flow means between open and closed conditions, and further comprising selecting means at the power supply means for selecting one of the open and closed conditions.

13. The apparatus according to claim 11, wherein the location is in a common area outside the units.

14. The apparatus according to claim 12, wherein the location is in a common area outside the units.

15. A method of managing an environment having independent units, comprising providing an apparatus according to claim 1.

16. The method of managing an environment having independent units, comprising providing an apparatus according to claim 2.

17. The method of managing an environment having independent units, comprising providing an apparatus according to claim 5.

18. The method of managing an environment having independent units, comprising providing an apparatus according to claim 6.

19. The method of managing an environment having independent units, comprising providing an apparatus according to claim 13.

20. The method of managing an environment having independent units, comprising providing an apparatus according to claim 14.
